(19) United States
(12) Patent Application Publication
(10) Pub. No.: US 2007/0109539 A1
(43) Pub. Date: May 17, 2007

(54) Method and apparatus for detecting defects using focus compensation

(76) Inventors: Lewis S. Damer, Saint Paul, MN (US); James M. Kopchinski, Beldenville, WI (US)

Correspondence Address: Pamela R. Crocker;Patent Legal Staff, Eastman Kodak Company, 343 State Street, Rochester, NY, 14650-2201, US

(21) Appl. No.: 11/280,791

(22) Filed: Nov. 16, 2005

(51) Int. Cl. G01N 21/84

(52) U.S. Cl. 356/431

(57) ABSTRACT

A method and apparatus for detecting a defect in an article that causes deflection of a beam when the beam strikes the defect. A beam used for detecting defects may be directed across at least a portion of the article. The distance traveled by the beam changes as the beam is directed across the article. The beam is focused correspondingly with the changing distance traveled by the beam.

### FIELD OF THE INVENTION

This invention relates to systems for detecting the deflection of a beam when the beam is directed at an article. More particularly, this invention relates to systems for detecting defects in (that is, within or on) moving articles, such as webs or films, by detecting the deflection of a beam directed at the article.

### BACKGROUND OF THE INVENTION

Detection of defects during production of articles, such as coated films or webs, allows the operator to take prompt corrective action to maximize quality. Fast corrective action is particularly important in the production of continuous articles. Removal or correction of defects in continuous articles can be difficult, and it is often economically prohibitive to separate sections with defects from the defect-free sections of that article. Defects in the center of a wound web or film may require a laborious secondary process to remove the defective sections and to splice the non-defective sections back together. If the web or film is later converted into discrete products, high converting waste can result. In either case, removal of defective sections is often not cost-effective and can result in the waste and disposal of the entire wound web or film.

Effective detection of defects can allow the operator to quickly mark the defects for the secondary removal process. Also, the operator can quickly adjust the primary process in which the defect originates to eliminate the cause of the defect and to minimize defects to an acceptable number. Additionally, detection of “pre-defect” symptoms can prompt the operator to adjust the process to avoid defects prior to their formation. The operator taking the corrective action can be human or automatic.

Apparatus to detect defects are well known. One type of defect-detecting apparatus is an image analyzer which compares an image of the article being inspected with either another image of the article or a programmed image. When the images contrast, the apparatus may consider the irregularity a defect. This type of apparatus can be very expensive depending on the sensitivity required and the type of defects being detected.

Another type of defect-detecting apparatus is the line scanning system. This system includes a laser beam, for example, which is repeatedly directed across the article being inspected. One embodiment of this system includes a photodetector which measures the intensity level of the beam after the beam passes through the article. When the beam is deflected by the article, its intensity is reduced and detected by the system. However, determining changes in intensity resulting from slight deflections is often difficult.

Another known embodiment of this system, rather than measuring intensity levels, includes a scanning beam, which is directed at the surface of the article at a small or zero-degree angle of incidence, and a photodetector having a limited collecting area. A small angle of incidence means that the beam is directed nearly perpendicular to the surface of the article. Directing the beam at a small angle of incidence is used when the beam reflected from the surfaces is also being collected in order to direct the reflected beam away from the source and toward the photodetector. Minimizing this angle is important so that the inspection system takes up the least amount of space. With this embodiment, when the laser beam travels through the article without being deflected by a defect, the laser beam is collected by the photodetector. If the beam strikes a defect which deflects the beam outside of the collecting area of the photodetector, the failure to collect the beam is sensed by the photodetector.

However, when the beam is deflected by a defect such that the beam still strikes the photodetector, the defect will not be sensed by this system. For example, the deflection due to a defect may be so slight that the beam still strikes a portion of the photodetector. Likewise, if a beam, which when not deflected by a defect strikes one edge of the photodetector, but, in fact, is deflected to just within the other edge of the photodetector, the system will not sense that defect.

It is also known that this type of laser scanning system could be arranged differently so that, rather than collecting an undeflected beam, the undeflected beam is stopped by a masking component. With this arrangement, the photodetector is positioned to collect the beam if the beam strikes a defect which deflects the beam outside of the area of the masking component and within the area of the photodetector. Again, the beam can be deflected by a defect and still be stopped by the masking component causing the system to fail to detect the defect. Consequently, this type of scanning system has a limited sensitivity to defects or variations which cause only slight beam deflection.

In addition, a system of this type which directs a laser across the entire surface of the article and generally perpendicular to that surface uses large optical elements, such as mirrors, lenses, or collectors. The cost of the optical elements required to scan a wide web in this way is significant, and cost-prohibitive for many applications.

Also known is a masking component made up of multiple perforated layers, called a Moire Deflectometer. The perforations of each layer are aligned with the perforations of the other layers such that a beam deflected to a different location within the area of the mask can pass through and strike the photodetector. However, the alignment requires a high degree of accuracy to function and is susceptible to even slight vibration of the article being inspected.

Still another known approach, disclosed in U.S. Pat. No. 5,559,341, involves directing a laser beam through a wide, transparent substrate at a high angle of incidence, for example, 78 degrees, and using a mask to block the beam when undeflected or insufficiently deflected by a defect. However, using this approach on a wide substrate or web with a non-moving scanner involves using a relatively large depth of field to achieve a reasonably uniformly focused scanning spot. More specifically, with this approach, a laser spot size of 0.6 millimeter at the center of a 53-inch wide web resulted in a cross-web spot dimension at that center of 2.90 millimeters (due to the high angle of incidence). As a result, this approach has limitations with respect to its ability to detect small defects, for example, defects smaller than 1 millimeter and in its ability to discern or resolve features of larger defects.

There is a need for a cost-effective scanning system for detecting smaller defects in wide substrates as well as for identifying the type of larger defects.

### SUMMARY OF THE INVENTION

One embodiment of the present invention is a method useful for detecting a defect in (that is, within or on) an article that causes deflection of a beam when the beam strikes the defect. This method can include directing a beam used for detecting defects across at least a portion of an article. The distance traveled by the beam changes as the beam is directed across the article. The beam can be focused correspondingly with the changing distance traveled by the beam.

Another embodiment of the invention is an apparatus useful for detecting a defect of an article that causes deflection of a beam when the beam strikes the defect. The apparatus can include means for directing a beam used for detecting defects across at least a portion of an article. The distance traveled by the beam changes as the beam is directed across the article. This embodiment can also include means for focusing the beam to correspond to the changing distance traveled by the beam.

Another embodiment of the invention is an apparatus useful for detecting a defect of an article that causes deflection of a beam when the beam strikes the defect. The apparatus of this embodiment can include at least a first optical element that directs a beam used for detecting defects across at least a portion of an article. The at least one optical element causes the distance that beam travels between the optical element and the article to change as the beam is directed across the article. This embodiment can also include at least a second optical element that focuses the beam to correspond to the changing distance traveled by the beam.

### BRIEF DESCRIPTION OF THE DRAWINGS

FIG. 1 is a schematic view of an apparatus according to one embodiment of the present invention.

FIG. 2 is a schematic view of a defect detectable by the present invention.

FIG. 3 is a schematic view of an apparatus according to another embodiment of the present invention.

### DETAILED DESCRIPTION OF THE INVENTION

The present invention provides a cost-effective scanning apparatus and method for detecting smaller defects in articles as well as for identifying the type of defects. The present can have broad application. It can be used to inspect a variety of articles, including long lengths of materials such as transparent films (with or without coatings thereon) and non-transparent or reflective webs. One approach is to use known optical elements, including for example lasers, mirrors, lenses, beam splitters, photomultiplier tubes, other sensors, signal processors, programmable controllers, computers, other control components, and software.

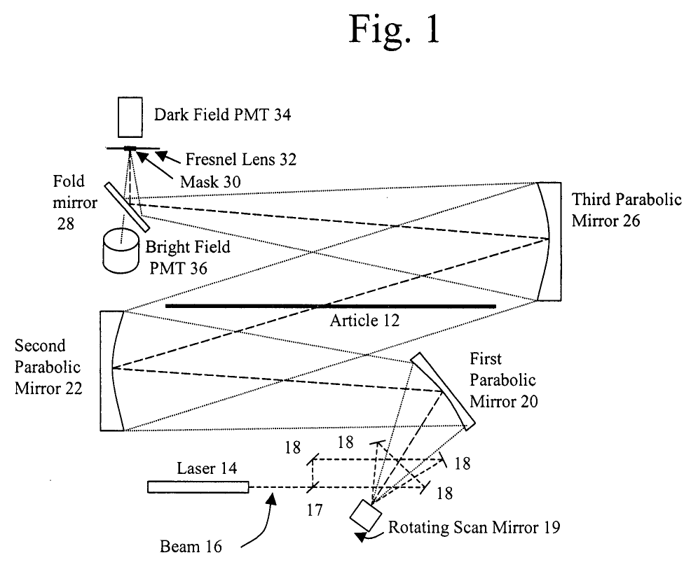

FIG. 1 illustrates one embodiment of an apparatus 10 useful for detecting defects in a transparent article 12 being moved or transported relative to the apparatus 10. Article 12 can be, for example, a polyester film-based substrate onto which an imaging composition has been coated. A specific example of this coated substrate is a precursor to a medical imaging film referred to as Kodak DryView™ film.

A laser 14 is shown generating a beam 16 that is split into two beams that are reflected by a group of adjustable mirrors 18. Adjustable mirrors 18 can, as their name implies, be adjustable to properly direct beam 16. Adjustable mirrors 18 direct one or both of the beams toward a rotating scan mirror 19 (e.g., 18-facet). The two split beams can be used in the inspection of article 12 (by reflecting from scan mirror 19), or one of the beams can be used in this function while the second beam is diverted from scan mirror 19 toward a sensor (not shown) that monitors the output of laser 14. (This and other embodiments of the present invention can include other components, aspects, or capabilities such as laser 14 having a typical focusing component. Similarly, the present invention can include a subsystem that controls the laser output based on the monitoring of laser 14 with the one split beam.)

From scan mirror 19, beam 16 scans over a first parabolic mirror 20. This mirror can have, for example, an 8-inch diameter and a 40-inch focal length. As shown, first parabolic mirror 20 is configured to change the distance traveled by beam 16 to a second parabolic mirror 22 (e.g., 16-inch diameter, 80-inch focal distance) that directs beam 16 to article 12. From the portion of apparatus 10 described to this point, apparatus 10 has created a substantially constant spot size (on article 12 as it is scanned across article 12). That is, this embodiment of the present invention focuses the beam 16 by changing the distance between one or more of the optical elements and by changing the optical strength of one or more of the focusing elements. In this specific embodiment, the distance is changed as a result of the beam 16 being scanned across first parabolic mirror 20. The optical strength is changed because the angle of incidence of beam 16 on first parabolic mirror 20 changes as the beam scans across this mirror.

The embodiment shown in FIG. 1 allows for a smaller and/or more uniform scanning spot, that is, as it strikes the article 12. In one embodiment, the spot can have a generally round, but somewhat elliptical shape with the major axis being generally parallel to the direction the article 12 is transported. The dimensions of the spot can be set as desired based on optical component selection and location. For example, the spot could have a major axis length of about 1.2 millimeters and a minor axis length of about 1.0 millimeter. This is in comparison to the spot that resulted from the use of the embodiment described in U.S. Pat. No. 5,559,341, which had a significantly larger major to minor axes ratio (i.e., more elliptical than round). The spot size could be other than about 1.2 millimeters by 1.0 millimeter for a particular use, such as a spot size of about 2.0 millimeters in the downweb direction and about 1.0 millimeter in the cross web direction to give better inspection coverage at higher speeds and similarly good resolution for smaller defects in the crossweb direction.

As for uniformity, the beam 16 created by the present invention remains significantly more uniform as it is scanned across the article 12. The above-described embodiment of the present invention and variations or alternatives thereof provide means for or has the effect of continuously compensating the focus of the beam 16 as the beam 16 is scanned across the article 12. Rather than to vary its substantially elliptical shape from about 3.0 millimeters by about 0.6 millimeter (when the spot is for example at the middle of the article 12) to about 4.5 millimeters by about 1.0 millimeter (when the spot is for example at each edge of the article 12), the shape of the spot created by the present invention can be maintained at substantially a single or constant spot size from edge to edge. As noted above, the spot size of the beam 16 can remain at about 1.2 millimeters by about 1.0 millimeter (or about 2.0 by about 1.0 millimeters) as the beam 16 is scanned across the article 12, or it can be similarly remain at still a different spot size.

As shown, beam 16 is directed toward article 12 with a ubstantially constant angle of incidence, for example, approximately 78 degrees. Because article 12 in this embodiment is transparent (or at least partially transparent) to beam 16, beam 16 passes through article 12 unless stopped or sufficiently deflected by a defect of (that is, in or on) article 12. Once through article 12, beam 16 reflects off a third parabolic mirror 26 to a flat mirror 28. Beam 16 reflects off flat mirror 28 toward a beam splitter (not shown) that directs one portion of beam 16 toward a mask (diffuser) 30 and a fresnel lens 32. The mask 30 is positioned to block that portion of the beam when it has not been sufficiently deflected by an anomaly (e.g., a defect as described above). The fresnel lens 32 is positioned to collect the portion of the beam that is not blocked by mask 30, i.e., the portion that was deflected by an anomaly (e.g., a defect as described) and to direct the deflected beam to a first sensor 34, such as a photomultiplier tube. (The beam 16 at this portion of apparatus 10 is shown being blocked by marks 30 rather than being collected by fresnel lens 32 and sensed by first sensor 32.) This first sensor 34 can be referred to as a dark field sensor because the region covered by sensor 34 is usually dark when beam 16 is applied to an article that includes an occasional, but relatively infrequent defect.

The second portion of beam 16 split off by the above-described beam splitter (not shown) is directed to a second sensor 36 that is positioned to receive beam 16 when it was not deflected (or significantly deflected) off course by article 12. This second sensor 36 can be referred to as a bright field sensor because the region covered by this sensor 36 is usually bright, i.e., usually receiving beam 16 when applied to an article that includes an occasional, but relatively infrequent defect. (The second sensor 36 is shown in position to receive the portion of beam 16 split off to second sensor 26, although it could be positioned differently using various optical elements, such as mirrors.)

The first and second sensors 34, 36 are part of two parallel signal processing systems that are used in the evaluation of the signals by converting the received beam 16 into electronic signals. These signals can be processed and evaluated by setting thresholds (e.g., an exceeded threshold can be equated to a defect). The resulting signals can indicate where the defect is on article 12 and how large (severe) it is. These signals can be processed, for example, using programmable controllers, computers, software, and other components, means, and approaches. The detection of undesirable defects permits subsequent steps that can involve, for example, the removal or marking of a portion of the article 12 that includes the defect. The present invention can also detect acceptable anomalies, which results in the acceptance and subsequent use and/or sale of the portions of article 12 that contain such anomalies (or that contain no acceptable or unacceptable anomalies).

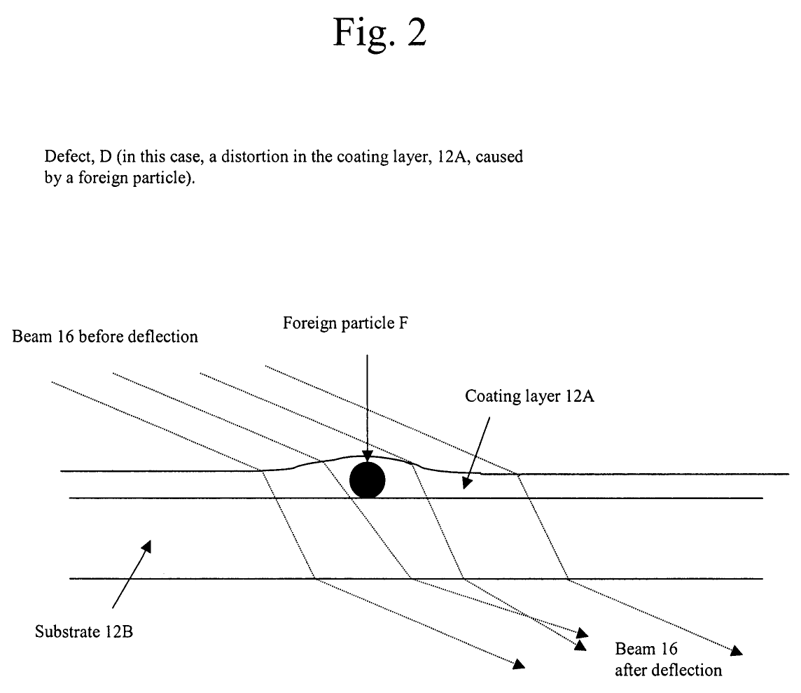

FIG. 2 illustrates beam 16 passing through article 12. Article 12 is shown as a coating 12A on a substrate 12B with a defect D located within the coating, i.e., a coated substrate. The defect D, such as a change to the coating surface made by the inclusion of a foreign particle F can appear as a distortion or bulge. As shown, beam 16 deflects, i.e., changes direction, due to the surface angle of coating 12A at the bulge or distortion. Not shown, beam 16 can actually strike foreign particle F and be entirely stopped or widely deflected. Another coating defect, not shown, is an area in which the coating is thinner than desired or even non-existent such that an area of substrate 12B is uncoated. The present invention is similarly capable of detecting these forms of defect based on the beam deflection that occurs.

Small defects due to foreign particle inclusions in a coating can be undesirable and, therefore, should be rejected when detected. For example, a defect can be approximately 1.5 millimeters in size or less. A defect of this type can give a signal pulse that is higher in amplitude (due to the resulting deflection) and shorter in duration that a larger, more gradual defect such as a five-millimeters in size or greater. A larger, more gradual defect may be a distortion in the substrate or backing and may not be sufficiently undesirable such that it should not be rejected, but accepted. These more gradual defects may cause a smaller (less amplitude) but longer duration signal pulse.

With the crossweb focus provided by the present invention (e.g., approximately one millimeter spot size across a 60-inch coated substrate), apparatus 10 could for a one-millimeter defect, for example, give a single signal pulse (e.g., equal to two millimeters crossweb), and could for a more gradual three-millimeter defect, for example, give two adjacent pulses (each of which would be equal to two millimeters crossweb). That is, the present invention could distinguish between these two types and/or sizes of defects and it could do so regardless of the location of the defect on the article 12. This can be important because it may be desirable to reject one defect or anomaly and to accept the other.

If the crossweb focus were not as good (for example, a three-millimeter spot size), a one-millimeter defect could give a single signal pulse (e.g., equal to four millimeters cross web), and three-millimeter defect could give a single pulse (e.g., equal to six millimeters crossweb). With this degree of crossweb focus, distinguishing between these two types or sizes of defects or anomalies is more difficult. Furthermore, without the ability to maintain the spot size as the beam 16 is scanned across the article 12, the ability to distinguish can be worsened.

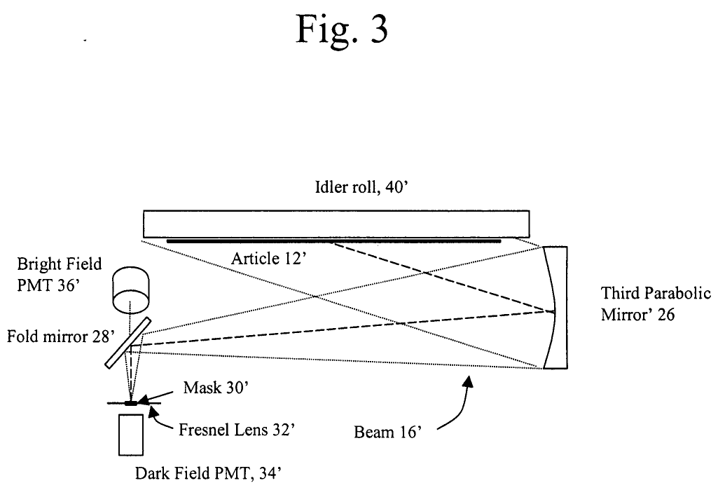

FIG. 3 illustrates another embodiment of the present invention. This apparatus 10′ is arranged to work with an article 12′ that is not transparent (or at least not entirely transparent) for the beam 16′, but rather, reflective (or at least partially reflective) to the beam 16′. As a result, the portion of apparatus 10′ that receives the beam 16′ after deflective from article 12′ is shown below article 12′ as opposed to above article 12 as shown in FIG. 1. Note that the portion of apparatus 10′ that generates beam 16′ and directs it toward article 12′ is not shown in FIG. 3. This portion of apparatus 10′ can be the same as the same portion in apparatus 10 shown in FIG. 1 and positioned below the article 12′ but such that it and the portion shown in FIG. 3 can fit within the space below the article 12′. FIG. 3 further shows an idler roll 40′ against which article 12′ can be supported when being transported. Instead, a group of idler rolls or an endless belt (not shown) could be used to provide further support or back-up for the transported article 12′. The same or a similar support or back-up approach can be used with the embodiment shown in FIG. 1 although it could be configured to not interfere with the beam 12 passing through article 12 to the sensors 34, 36 positioned above article 12.

One of many variations on the embodiment shown in FIG. 1 or FIG. 3 may, instead of photomultiplier tubes 34, 36 shown herein, involve the use of an annularly shaped photomultiplier tubes like or much like the one shown in FIG. 9 of U.S. Pat. No. 5,559,341. That figure and the remainder of that patent are hereby incorporated by reference into this disclosure. That embodiment would not require the beam splitter referred above that is used in conjunction with first and second sensors (photomultiplier tubes) 34, 36. A similar variation could be the use of only one of the two sensors 34, 36 and corresponding downstream signal processing and defect detection approach.

Another variation could involve changing the focus (e.g., spot size) of the beam 16 by further changing the spacing between the focusing optical elements, for example, by moving the noted elements farther apart or closer together. Still another variation could involve further changing the optical strength of one or more of the focusing elements, for example, by selecting other elements. These and other variations could be used alone or in combination.

Although the present invention has been described with reference to preferred embodiments, workers skilled in the art will recognize that changes may be made in form and detail without departing from the spirit and scope of the invention. In addition, the invention is not to be taken as limited to all of the details, aspects, or means of the noted embodiments as modifications, variations, and combinations thereof may be made without departing from the spirit or scope of the invention.

What is claimed is:

1. A method useful for detecting a defect in an article that causes deflection of a. beam when the beam strikes the defect, comprising:
directing a beam used for detecting defects across at least a portion of an article, wherein the distance traveled by the beam changes as the beam is directed across the article; and
focusing the beam to correspond to the changing distance traveled by the beam.

2. The method of claim 1, wherein focusing comprises positioning a first optical element to receive the beam, wherein the first optical element is positioned and configured to alter the distance that the beam travels between the first optical element and a second optical element as the beam strikes different positions on the first optical element.

3. The method of claim 1, wherein the first and second optical elements comprise parabolic mirrors.

4. The method of claim 1, wherein the focusing maintains a substantially constant spot size of the beam as the beam is directed across the article.

5. The method of claim 1, wherein focusing maintains a substantially constant spot shape of the beam as the beam is directed across the article.

6. The method of claim 1, wherein the beam is a laser beam, wherein focusing is continuous as the laser beam is directed across the article, and wherein the method further comprises generating the laser beam.

7. The method of claim 1, wherein the beam is directed across the article in a substantially parallel scanning range so that the beam strikes the portion of the article being scanned at a substantially constant angle of incidence.

8. The method of claim 7, wherein the angle of incidence is within a range of about 70 degrees to about 90 degrees.

9. The method of claim 1, further comprising transporting the article when the beam is being directed and focused.

10. The method of claim 1, wherein the article is a flexible substrate and wherein the flexible substrate is not supported by a back-up member beneath where the beam strikes the flexible substrate during the directing step.

11. The method of claim 1, further comprising positioning a first sensor relative to the article to sense the beam when the beam is deflected sufficiently off course by striking the defect.

12. The method of claim 11, further comprising positioning a second sensor relative to the article to sense the beam when the beam is not deflected or sufficiently deflected off course by striking the defect.

13. The method of claim 1, further comprising sensing a defect in the article by sensing a deflection of the beam caused by the defect.

14. An apparatus useful for detecting a defect in an article that causes deflection of a beam when the beam strikes the defect, comprising:
means for directing a beam used for detecting defects across at least a portion of an article, wherein the distance traveled by the beam changes as the beam is directed across the article; and
means for focusing the beam to correspond to the changing distance traveled by the beam.

15. The apparatus of claim 14, wherein the directing means comprises a rotating mirror and the focusing means comprises a parabolic mirror.

16. The apparatus of claim 14, wherein the directing means comprises at least one parabolic mirror configured such the beam has a substantially constant angle of incidence when directed over the article.

17. The apparatus of claim 14, wherein the directing means comprises at least one mirror to change the direction of the beam and a beam splitter.

18. The apparatus of claim 14, wherein the focusing means is configured to maintain a substantially constant spot size of the beam as the beam strikes the article.

19. The apparatus of claim 14, further comprising means for sensing the beam when the beam has been deflected by the defect.

20. An apparatus useful for detecting a defect in an article that causes deflection of a beam when the beam strikes the defect, comprising:
at least a first optical element that directs a beam used for detecting defects across at least a portion of an article, wherein the at least one optical element causes the distance that the beam travels between the optical element and the article to change as the beam is directed across the article, wherein the at least a first optical element comprises at least one of a scanning mirror and a parabolic mirror; and
at least a second optical element that focuses the beam to correspond to the changing distance traveled by the beam, wherein the at least a second optical element comprises a parabolic mirror, and wherein the at least a second optical element is configured to focus the beam such that a substantially constant spot size of the beam on the article is maintained as the beam is directed across the article.
